(19) United States
(12) Patent Application Publication
(10) Pub. No.: US 2015/0051327 A1
(43) Pub. Date: Feb. 19, 2015

(54) FLAME RETARDER COMPRISING CONDENSED PHOSPHONIC ACID ESTER AND FLAME-RETARDANT RESIN COMPOSITION

(71) Applicant: MARUBISHI OIL CHEMICAL CO., LTD., Osaka-shi, JP (US)

(72) Inventors: Junichi Kobayashi, Izumiotsu-shi (JP); Akira Ishikawa, Izumiotsu-shi (JP); Kai Miwa, Izumiotsu-shi (JP); Shigeto Iguchi, Izumiotsu-shi (JP)

(73) Assignee: MARUBISHI OIL CHEMICAL CO., LTD., Osaka-shi (JP)

(21) Appl. No.: 14/235,149

(22) PCT Filed: Jul. 26, 2012
(86) PCT No.: PCT/JP2012/069009

§ 371 Date: Oct. 27, 2014

(30) Foreign Application Priority Data
Jul. 28, 2011 (JP) 2011-166090

(51) Int. Cl. C08K 5/5357

(52) U.S. Cl. CPC C08K 5/5357
USPC 524/119; 558/76

(57) ABSTRACT

The main objection of the present invention is to provide a halogen-free flame retardant for resins which has a high heat resistance and is capable of exhibiting excellent flame retardance while maintaining a good transparency. The present invention provides a flame retardant for resins which includes a condensed phosphonic acid ester having a specific chemical structure, a flame-retarded resin composition containing the same, and a molded article made from the composition.

### TECHNICAL FIELD

The present invention relates to novel flame retardants and novel flame-retarded resin compositions. The present invention relates in particular to internal additive-type flame retardants for synthetic resins, with these flame retardants including a condensed phosphonic acid, ester having high heat resistance, and the present invention also relates to synthetic resin compositions containing such flame retardants, and to articles molded or extruded from such, resin compositions. More specifically, the present invention relates to environmentally friendly, halogen-free flame-retarded synthetic resin compositions, which are useful for producing injection-molded articles and extruded articles, and to molded or extruded articles obtained therefrom which are suitable for use as, for example, electrical appliances, office automation equipment and automotive components. The present invention also relates to halogen-free flame-retarded resin compositions and molded or extruded articles obtained therefrom which are suitable for use as, for example, electrical appliances, office automation equipment and automotive components, and which moreover have a high heat resistance and are also capable of effectively exhibiting the intrinsic properties of the resin.

### BACKGROUND ART

Thermoplastic resins such as polyolefin resins, polystyrene resins, polyacrylic resins, polyamide resins, polyester resins, polyether resins, polycarbonate resins and thermoplastic urethane resins; thermoset resins such as phenolic resins and epoxy resins; and polymer alloys arrived at by combinations thereof are used in accordance with their mechanical, thermal, and molding and processing properties in a broad range of industrial products such as construction materials, materials for electrical equipment, vehicular components, automotive interior components and household articles.

Of these, non-crystalline resins such as polystyrene resins, polyacrylic resins, polyether resins, polycarbonate resins and polyvinyl chloride resins generally have a high transparency; many of these are resins endowed with excellent impact resistance, electrical properties, dimensional stability and weather resistance which are used in a broad range of applications. These non-crystalline resins, in addition to use in applications requiring transparency, such as lenses, eyeglasses, prisms and optical disks, are seeing expanded use in other applications as well, arch as electrical appliance components, computer parts, cell phone parts, electrical and electronic parts and parts for handheld data devices, thus creating a desire for additional properties such as a high degree of flame retardance (in moldings such as housings in particular, a high degree of flame retardance in moldings which are thin-walled for reduced weight).

However, because these synthetic resins generally have the drawback ox being flammable, a variety of methods have been proposed for flame-retarding these synthetic resins. A common way to impart flame retardance to synthetic resins is to blend a flame retardant into the resin. Of the flame-retarding methods used to date, those in most common use entail the addition of antimony oxide and a halogenated organic compound. Halogenated organic compounds that may be used include tetrabromobisphenol A, hexabromocyclododecane, the bisdibromopropyl ether of tetrabromobisphenol A, the bisdibromopropyl ether of tetrabromobisphenol S, tris(2,3-dibromopropyl) isocyanurate, bistribromophenoxyethane, hexabromobenzene and decabromobiphenyl ether.

However, given the increased awareness lately of global environmental problems, there exists a strong desire for moderation in the use of halogenated organic compounds which tend to generate noxious gases (hydrogen bromide) upon combustion. Moreover, when it comes to the halogenated flame retardants mentioned above, especially with regard to their use in non-crystalline resins having a high transparency, although good flame retardance can be ensured, suppressing the loss of clarity and increased base associated with the addition of such flame retardants is quite difficult.

In light of the above, a number of methods for imparting flame retardance to synthetic resins without using halogenated flame retardants have been described. One of these is a method that involves the addition of an inorganic hydroxide such as aluminum hydroxide or magnesium hydroxide. However, because flame retardant properties by inorganic hydroxides arise due to the water that forms from thermal decomposition, it is known that flame retardance is not manifested unless the inorganic hydroxide is added in a considerably large amount. Moreover, inherent qualities of the resin such as processability and mechanical properties end up being greatly diminished.

The use of phosphoric acid salts such as ammonium polyphosphates has been often described as another approach which does not entail the use of halogenated flame retardants. However, when a large amount of such a phosphoric acid salt is added, although the flame retardant properties can be adequately maintained, the water vapor resistance is diminished, resulting in a marked decline, due to water absorption, in the appearance and mechanical properties of molded or extruded products. Also, phosphoric acid salt bleedout arises on the surface of plastic molded or extruded products made of compositions containing such flame retardants, in addition to which numerous blooms arise, which is a critical defect.

To overcome the above drawbacks, coated ammonium polyphosphates obtained using melamine crosslinking, phenol crosslinking or epoxy crosslinking surface treatment agents, or using silane coupling agents and end-capped polyethylene glycol crosslinking surface treatment agents have also been proposed. However, such an approach has resulted in poor resin compatibility or dispersibility and a decline in mechanical strength. Moreover, when a resin composition containing a large amount of coated ammonium polyphosphate is kneaded, the coating often breaks down under the effect of heat and stress, giving rise to the same problems as described above.

In general, because ammonium polyphosphate-containing resin compositions thermally decompose with the heating and elimination ox ammonia gas from about the point where the temperature during kneading exceeds 200° C., the thermal decomposition products end up bleeding out during kneading, giving rise to water wetting of the strand. This dramatically worsens the physical properties and productivity of flame-retarded resin compositions. Moreover, in cases where a phosphoric acid salt is blended into a resin having a high transparency such as polycarbonate, the poor resin compatibility leads to a loss of clarity.

The use of organophosphorus compounds such as triphenyl phosphate or tricresyl phosphate to address this problem is known. However, such organophosphorus compounds are phosphoric acid ester-type flame retardants; when kneaded under applied, heat at an elevated temperature together with a synthetic resin such as a polyester, a transesterification reaction arises, markedly lowering the molecular weight of the synthetic resin and resulting in a decline in the physical properties inherent to the synthetic resin. Moreover, there is a possibility that the phosphoric acid ester-type flame retardant itself will, gradually hydrolyze due to moisture in air, forming phosphoric acid. When phosphoric acid has formed in the synthetic resin, this may lower the molecular weight of the synthetic resin; when the resin is used in applications such as electrical or electronic parts, a short-circuit may arise.

In resins intended for optical applications, in addition to an excellent transparency or hue, other properties such as thermal stability and melding processability are also often desired. However, problems that occur during the molding of such resin compositions include resin embrittlement or deterioration, resin discoloration and hue deterioration by the phenol derivatives, phosphoric acids and the like that form due to thermal decomposition or hydrolysis of the phosphoric acid ester-type flame retardant when the resin remains in the system as continuous processing is carried out over an extended period of time. Moreover, resolving the decline in resin processability that occurs due to the inclusion of a phosphoric acid ester flame retardant entails many difficulties.

In addition, phosphoric acid ester-type flame retardants, in addition to having a low flame retardance and excellent thermal decomposability, also are volatile. Accordingly, it is known that such flame retardants decompose during the granulation or molding of flame-retarding resins, or that the flame retardant itself volatilizes as a fume, markedly worsening the processability.

Resin compositions in which these monomer-type phosphoric acid esters and phosphonic acid esters are used as the flame retardant sometimes give rise to what is referred to as “juicing”; that is, the heat resistance undergoes a large decline and flame retardant volatilizes during injection molding, depositing on the surface of the molded product so that whitening sometimes occurs. The method often used to suppress such juicing is to increase the molecular weight and suppress volatilization. Although such resin compositions are improved in terms of juicing and heat resistance compared with monomer-type phosphoric acid esters and phosphoric acid esters, the flame retardance tends to decrease. To maintain a high degree of flame retardance, it is thus necessary to further increase the amount of flame retardant added. As a result, the balance among the properties of the resin, such as flame retardance, physical properties and optical characteristics, is largely lost. Flame retardants which overcome this problem have yet to be found.

Various condensed phosphoric acid esters of increased molecular weight have hitherto been developed to resolve this problem. Three types of condensed phosphoric acid esters having, respectively, chemical formula (1), chemical formula (2) and chemical formula (3) below are currently in wide use.

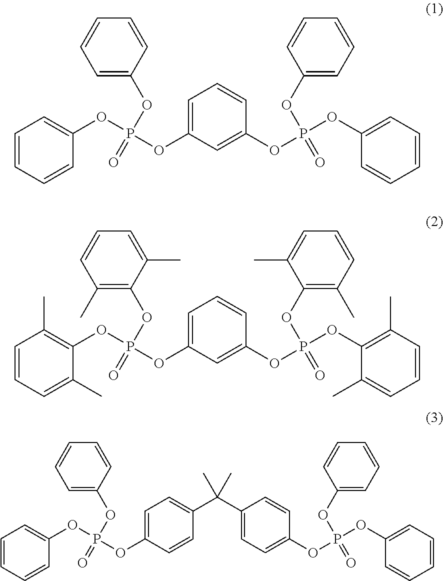

Although condensed phosphoric acid ester-type flame retardants of this type have a high heat resistance and the flame retardant itself substantially does not decompose or volatilize during processing of the resin, because compounds (1) and (3) are viscous liquids at standard temperature and compound (2) has a melting point of 100° C. or below, these flame retardants exhibit very strong plasticizing properties on resins.

When a large amount of this flame retardant is added to the resin, the fluidity of the flame-retarded resin composition becomes much too high, as a result of which the appearance, physical properties and the like of the molded product end up declining dramatically. This is the same sort of problem as occurs with conventional phosphoric acid ester-type flame retardants.

As for phosphorus-containing organic compounds other than the above, there do not yet exist any flame retardants which achieve, over a broad range of applications for many synthetic resins, a good balance of flame retardance, resin compatibility of the flame retardant, and mechanical properties and stability of the resin. This is due to differences in the flame-retarding mechanism between halogenated flame retardants and halogen-free flame retardants.

As has been described in many technical documents, during the combustion of resins and the like, large amounts of hydrocarbons are generated as a result of pyrolysis and a radical chain reaction explosively arises in which these hydrocarbons, under the effects of active H radicals and active OH radicals generated at the same time in a vapor phase, become hydrocarbon radicals that, upon oxidizing, once again generate active radicals. To effectively suppress such combustion, an element or compound which stabilizes the active radicals by a radical trapping effect in the vapor phase or which has a radical decaying effect must be formulated within the resin. Flame retardants which contain halogens that are vaporizable elements, and especially chlorine and bromine, are reportedly the most effective.

Therefore, during combustion in cases where the temperature at which resin pyrolysis begins (hydrocarbon radical generating temperature) and the thermal decomposition temperature of the flame retardant included in the resin (halogen radical generating temperature) are both the same, active radicals are captured at once from the start of combustion in a vapor phase. In this way, although there are influences on the compatibility with each resin and on the resin properties in the vapor phase, halogenated flame retardants can be used as effective flame retardants on a broad range of resins.

By contrast, in the case of common phosphoric acid salt and phosphoric acid ester-type phosphorus compounds such as red phosphorus, because the phosphorus itself is not a vaporizable element, these have no effect as radical trapping agents in the vapor phase. Although a portion of the phosphoric acid ester that has thermally decomposed is present in the vapor phase as phosphorus oxide radical-containing decomposition products, during combustion, most of the phosphorus-based flame retardant exists in a phase other than the vapor phase, such as a solid phase, molten phase or liquid phase. The flame retardant becomes a decomposed active species and, by inducing dehydration and oxidation reactions on oxygens or aromatic rings in the resin, causes a nonflammable carbide layer (char) to form, interrupting the supply of heat from a flame or of oxygen to the combustion source, and thus suppressing the continued combustion. That is, when the rate of oxygen interruption and heat transport interruption (thermally insulating layer formation) due to char formation during combustion is compared with the rate of the radical chain reaction that is explosively triggered by the hydrocarbons generated due to resin pyrolysis and the active radicals that are generated at the same time, the vapor phase reactions are overwhelmingly faster. Hence, halogenated flame retardants are thought to be more effective than phosphorus-containing flame retardants.

Therefore, common phosphorus-containing flame retardants do not contribute much to suppressing their own combustion, even when they self-decompose due to combustion. Hence, the need for a char-forming source such as the resin itself or some other additive. This narrows the range of application in terms of the types of resins, so that only selective use is regarded as possible. Accordingly, there exists a need for the development of a flame retardant which has a non-halogen element or a structure with radical trapping effects in the vapor phase due to thermal decomposition during combustion.

Compounds containing structural units of the following chemical formulas (4) and (5) have been proposed as additives for polyester flame retardants (Patent Document 1).

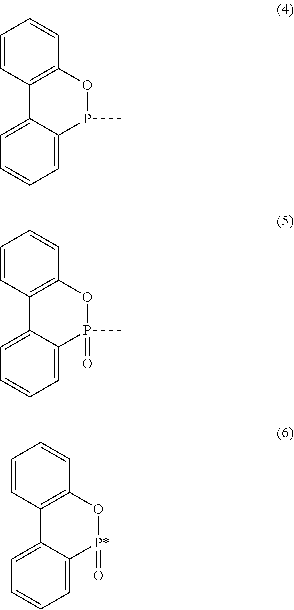

Of these, the group of compounds containing the trivalent phosphorus atom shown in chemical formula (4) has a low heat resistance and a low durability to hydrolysis, and are thus highly unstable. When such compounds are kneaded under applied heat with various synthetic resins, judging from their volatility, heat resistance, water resistance and the like, and also their influence on properties inherent to the synthetic resin, further improvement is required.

Of the group of compounds containing the pentavalent phosphorus atom shown in chemical formula (5), there exist several compounds which have a high degree of flame retardance and have been studied from various perspectives. This is because the 9,10-dihydro-9-oxo-10-phosphaphenanthrene-10-oxide-10-yl radical of above chemical formula (6), which is encompassed by chemical formula (5), is capable of being relatively stably present in the vapor phase as a radical during combustion. This radical, is thought to behave as a radical scavenger which captures and stabilises active radicals that promote combustion.

Hence, although it would be possible to use compounds capable of generating the above radicals during combustion as flame retardants, Patent Document 1 states that the use of compounds having a reactivity with the polyester main chain, compounds having a large molecular weight and metal salts as the flame retardants is more preferable.

When a flame retardant having reactivity with OH groups and the like is added during the production of polyester flame-resistant fibers, it is possible to more strongly incorporate the flame-retarding structure within the polyester molecule by way of copolymerization or transesterification with the polyester-forming components themselves. However, particularly when kneading under applied heat is carried out at an elevated temperature of at least 250 to 300° C., as in the case of polycarbonate or polybutylene terephthalate, blending a flame retardant having direct reactivity with the synthetic resin has the undesirable effects of markedly lowering the molecular weight of the synthetic resin and bringing about an excessive loss in the properties inherent to the synthetic resin. It is therefore necessary for flame retardants that are to be exposed to molding operations to be sufficiently inert compounds which have no reaction sites for the synthetic resin.

Patent Document 1 also discloses, as condensed esters having a high heat resistance, large molecular weight compounds such as flame retardants of chemical, formulas (7) and (8) below, examples of which include the reaction product of bisphenol S or bisphenol A with 9,10-dihydro-9-oxo-10-phosphaphenanthrene-10-oxide.

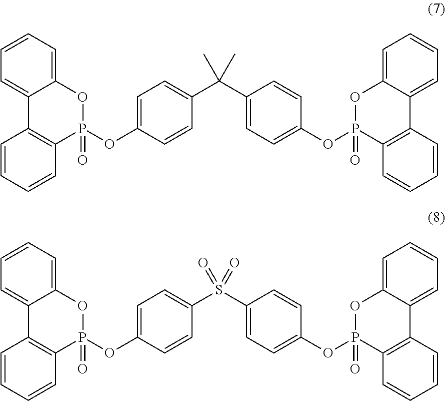 [SMILES: CC(C)(c1ccc(OP2(=O)Oc3ccccc3-c3ccccc32)cc1)c1ccc(OP2(=O)Oc3ccccc3-c3ccccc32)cc1 ; O=P1(Oc2ccc(S(=O)(=O)c3ccc(OP4(=O)Oc5ccccc5-c5ccccc54)cc3)cc2)Oc2ccccc2-c2ccccc21]

However, in the case of compound (7) and compound (8) flame retardants, because the thermal decomposition starting point, inherent to the compound (temperature at which 9,10-dihydro-9-oxo-10-phosphaphenanthrene-10-oxide-10-yl radicals are generated) is too high and thermal decomposition is incomplete even at above 600° C. in thermogravimetry (TG), it has been found that the radicals shown in chemical formula (6) above are not effectively generated by thermal decomposition. Moreover, with regard to condensed ester compounds of above compound (5) with molecules having too large a molecular weight such as bisphenols (including bisphenol A and bisphenol S), because the molecular weight of the radical of chemical formula (6) is also large (Mw, 215.16), the content of the chemical formula (5) compound in the flame retardant structure formula is relatively small. Hence, if is apparent that the flame retarding properties are also considerably diminished.

Therefore, in the case of above Compounds (5) and (6), relatively large amounts must be added to resins requiring a high degree of flame retardance. As a result, decreases in the physical, and optical properties of the resin due to the addition of a large amount of condensed ester flame retardant cannot be avoided, making the use of these compounds problematic for conferring a high degree of flame retardance.

By contrast, a small molecular weight compound such as 9,10-dihydro-9-oxo-10-methyl-10-phosphaphenanthrene-10-oxide, when used as a flame retardant containing the 9,10-dihydro-9-oxo-10-phosphaphenanthrene-10-oxide-10-yl radical shown in chemical formula (6) as a structural unit, given that it has a low thermal stability and thermal decomposition starts at a decomposition starting temperature in thermogravimetry (TG) of 200° C. or below, ends up thermally decomposing during kneading under applied, heat at an elevated temperature, and may thus be regarded as unfit for practical use as a flame retardant for resin addition.

The present applicant has earlier disclosed, as a flame retardant having practical utility for addition in resins, a flame retardant containing a phosphoric acid ester having a 9,10-dihydro-9-oxo-10-phosphaphenanthrene-10-oxide structure (Patent Document 2). This phosphonic acid ester imparts a high degree of flame retardance to various resins, and is moreover a special flame retardant having various excellent physical properties. However, because this compound, is observed to generate some fumes due to volatilization when heated to 250 to 300® C., its heat resistance as a flame retardant for engineering plastics when exposed to temperatures in excess of 300® C., particularly during kneading with resins, is not entirely satisfactory. Hence, in this respect, there remains room for improvement.

As shown above, there do not yet exist halogen-free flame retardants which have a high resin compatibility, allow the resin to manifest high mechanical, properties, optical properties and heat resistance, and exhibit a very high degree of flame retardance when added in relatively small amounts.
Patent Document 1: Japanese Patent Application Publication No. S53-56250
Patent Document 2: Japanese Patent Application Publication No. 2010-124204

### DISCLOSURE OF THE PRESENT INVENTION

Accordingly, the main object of this invention is to provide a halogen-free flame retardant for resins which exhibits excellent flame retardance due to a high heat resistance while maintaining a good transparency and other properties.

In light of the above-described problems with the conventional technology, the inventors have conducted extensive investigations. As a result, they have found that flame retardants containing specific condensed phosphonic acid esters are able to achieve the above object and arrived at the present invention.

That is, this invention relates to flame retardants for resins which include the following condensed phosphonic acid ester, flame-retarding resin compositions containing such flame retardants, and molded articles made thereof.

1. A flame retardant for resins which includes a condensed phosphonic acid ester represented by general formula (I) below:

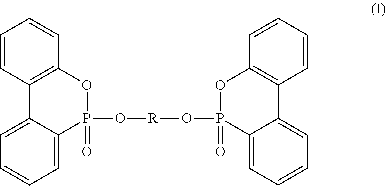

wherein R is a C₁₋₁₁ alkylene group, arylene group, cycloalkylene group, heteroalkylene group, heterocycloalkylene group or heteroarylene group which may have a substituent.
2. A flame-retarding resin composition which includes the flame retardant of 1 above and a resin component, wherein the composition contains 1 to 100 parts by weight of the condensed phosphonic acid ester per 100 parts by weight of the resin component.
3. The flame-retarding resin composition of 2 above, wherein the resin component is a polycarbonate resin.
4. The flame-retarding resin composition of 3 above, wherein the polycarbonate resin has a melt volume flow rate of from 1 to 30.
5. A flame-retarded resin molded article which is obtained by molding the flame-retarded resin composition according to any of 2 to 4 above.
6. The flame-retarded resin molded article according to 5 above which is for use in electrical and electronic components, office automation equipment components, electrical appliance components, automotive components or machinery components.

Because the flame retardant of this invention includes a condensed phosphonic acid ester having a specific chemical structure and a high heat resistance, even though the content of flame retardant within the synthetic resin is small, it is able to confer the resin with a high degree of flame retardance. In addition, because this phosphonic acid ester serving as the active ingredient in the flame retardant of the present invention does not include halogen atoms within the molecule, the generation of noxious gases is suppressed even when burning of the flame-retarded resin compositions and molded articles made therefrom occurs. Therefore, flame-retarded resin compositions and molded articles containing the flame retardant of the present invention are capable of exhibiting a high degree of flame retardance equal to or better than that in the conventional art while at the same time maintaining the properties inherent to the resin component. In particular, the flame retardant of the present invention is capable of exhibiting a better performance on polycarbonate resins.

Moreover, when the flame retardant of the present invention is blended into a resin, the transparency of the resulting composition is also good. Hence, along with addition of a small amount of flame retardant as indicated above, it can be advantageously used for flame-retarding resins having a high transparency or resins required to have optical characteristics.

Molded or extruded articles according to the present invention obtained by the formulation of a flame retardant having such characteristics may be favorably used in, for example, the internal components and housings of office automation equipment and electrical appliances, and in components required to have flame retardance in the automotive field and elsewhere. More specifically, molded or extruded articles according to the present invention may be used in, for example, insulation-coated materials such as electrical wires and cables and various electrical components; various automotive applications such as the instrument panel, center console panel, lamp housing, lamp reflector, corrugated tubing, wire coatings, battery parts, car navigation components and car stereo components; boats, aircraft components, various home equipment components such as sink components, toilet components, bathroom components, floor heating components, lighting fixtures and air conditioners; various construction materials such as roofing materials, ceiling material, wail materials and flooring materials; and electrical and electronic components such as relay cases, coil bobbins, light pickup chassis, motor case, notebook computer housings and internal components, CRT display housings and internal components, printer housings and internal components, handheld device housings and internal components, recording media (CDs, DVDs, PDs, etc.), driver housings and internal components, and copier housings and internal components. Such molded or extruded articles can also be advantageously used, in applications such as household electrical appliances such as television sets, radios, video and audio recording devices, washing machines, refrigerators, vacuum cleaners, cookers and lamps, and are useful as well in various machine components and miscellaneous other applications.

### BRIEF DESCRIPTION OF THE DRAWING

FIG. 1 shows a front view (A) and side view (B) of the test pieces fabricated when evaluating the optical properties of molded or extruded articles in the examples.

### BEST MODE FOR CARRYING OUT THE PRESENT INVENTION

The internal addition type flame retardant for synthetic resins which includes a condensed phosphonic acid ester, the flame-retarding synthetic resin composition using such a flame retardant, and the molded articles obtained therefrom according to the present invention are described in detail below.

### 1. Flame Retardant for Resins

### (1) Condensed Phosphonic Acid Ester and Method of Preparation Thereof

The flame retardant for resins of the present invention (the present flame retardant) is characterised by including a condensed phosphonic acid ester represented by general formula (I) below

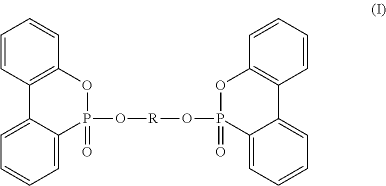

wherein R is an alkylene group, arylene group, cycloalkylene group, heteroalkylene group, heterocycloalkylene group or heteroarylene group, wherein the group has a total carbon number of from 1 to 11 which may have a substituent.

That is, the condensed phosphonic acid ester of general formula (I) (also referred to below as “the condensed phosphonic acid ester of the present invention”) functions as the active ingredient of the present flame retardant. The present flame retardant includes one or more types of inventive condensed phosphonic acid ester.

R in general formula (I) is an alkylene group, arylene group, cycloalkylene group, heteroalkylene group, heteroarylene group or heterocycloalkylene group which may have a substituent.

The substituent may be any substituent other than a halogen, examples of which include nitrogen-containing substituents such as amino groups, amide groups and nitro groups; sulfur-containing substituents such as sulfonic acid groups; and carbon-containing substituents such as carboxyl groups and alkoxy groups.

The carbon number of R is from 1 to 11. When the group has a substituent(s) containing carbons, the carbon number includes those of the substituent.

The alkylene group may be either a straight chain or branched alkylene group. Illustrative examples include methylene, ethylene, propylene, isopropylene, butylene, isobutylene, pentylene, isopentylene, neopentylene, hexylene, heptylene, octylene, nonylene and decylene groups. In this invention, preferred use can be made of an alkylene which is unsubstituted. The number of carbons on such alkylene groups is preferably from 1 to about 11, and more preferably from about 2 to about 6.

The arylene group may be any cyclic group (any monocyclic, condensed polycyclic, cross-linked ring or spirocyclic group) which may have a substituent. Illustrative examples include monocyclic, bicyclic and tricyclic arylene groups such as phenylene, pentalenylene, indenylene, naphthalenylene, azulenylene, phenalenylene and biphenylene groups. The R in general formula (I) is preferably an arylene group having a carbon number of 6 to 11 carbons, such as a phenylene group or a naphthalene group. In the present invention, a phenylene group is more preferred.

The cycloalkylene group may be any cyclic group (any hydride of a monocyclic, condensed polycyclic, cross-linked ring or spirocyclic group) which may have a substituent. Illustrative examples include cyclopropylene, cyclobutylene, cyclopentylene, cyclohexylene, cycloheptylene and cyclooctylene groups. The R in general formula (I) is preferably a cycloalkylene group having from 3 to 8 carbons.

The heteroalkylene group is exemplified by groups in which at least one carbon atom making up the above-described alkylene group has been replaced with a hetero atom, (in particular, at least one from, among an oxygen atom, a nitrogen atom and a sulfur atom). The R in general formula (I) is most preferably a heteroalkylene group having a carbon number of 1 to 11 in which the heteroatom is an oxygen atom. Preferred examples include 3-oxapentalene, 3,6-dioxaoctylene, 3,6,9-trioxaundecalene, 1,4-dimethyl-3-oxa-1,5-pentylene, 1,4,7-trimethyl-3,6-dioxa-1,8-octylene and 1,47,10-tetramethyl-3,6,9-trioxa-1,11-undecene. Of these, 3-oxapentylene and 1,4-dimethyl-3-oxa-1,5-pentylene are preferred.

The heterocycloalkylene group is exemplified by groups in which at least one carbon atom on the above-described cycloalkylene group has been replaced with a heteroatom (in particular, at least one atom selected from among oxygen, nitrogen and sulfur atoms). The R in general formula (I) is preferably a cyclic heteroarylene group with a 5-membered ring or a 6-membered ring. Preferred examples include piperidinediyl, pyrrolidinediyl, piperazinediyl, oxacetanediyl and tetrahydrofurandiyl groups.

The heteroarylene group is exemplified by groups in which at least one carbon atom on the above-described arylene group has been replaced with a heteroatom (in particular, at least one atom from among oxygen, nitrogen and sulfur atoms). The R in general formula (I) is preferably a cyclic heteroaryl group with a 5-membered ring or a 6-membered ring. Preferred examples include furandiyl, pyrrolidinediyl, pyridinediyl, pyrimidinediyl, quinolidinediyl and isoquinolinediyl groups.

Illustrative examples of the condensed phosphonic acid ester of general formula (I) include the compounds of formulas (9) to (18) below. Known or commercially available compounds may be used directly as these compounds. Alternatively, these compounds may foe prepared by a known method of synthesis.

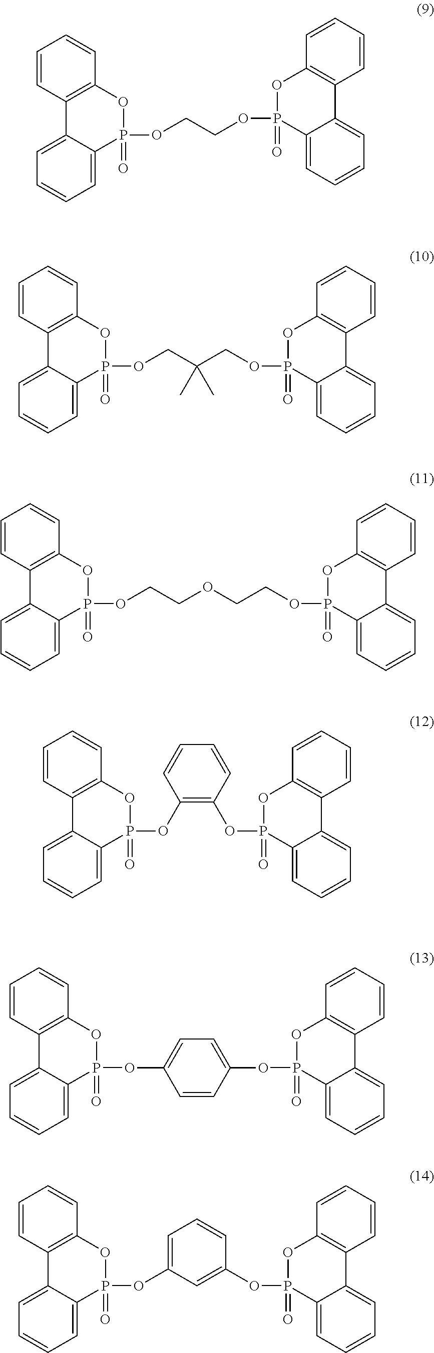

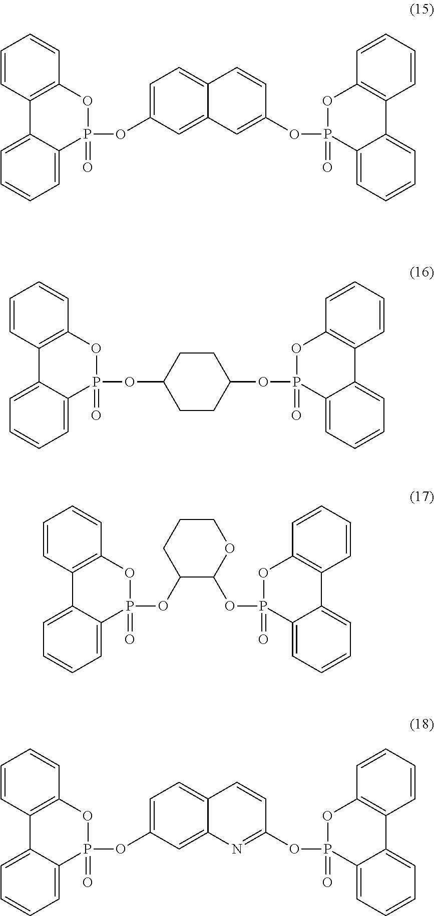

In the present invention, in cases where R in general formula (I) has the number of carbons greater than 11, the content within the condensed phosphonic acid ester molecule of 9,10-dihydro-9-oxo-10-phosphaphenanthrene-10-oxide-10-yl groups that exhibit a radical trapping ability is relatively low. Therefore, in this invention, the number of carbons on R is set to 11 or less, and preferably from 2 to 10, so that the compound of general formula (I) exhibits a high flame retardance.

When preparing a condensed phosphonic acid ester of above general formula (I), the method of preparation is not particularly limited. For example, preparation may foe suitably carried out by the method of preparing phosphonic acid esters described in Japanese Patent Application Publication No. 2009-108089.

Alternatively, as in the case of the method, of preparing phosphonic acid esters described in Japanese Patent Application No. 2010-27046, a condensed phosphonic acid ester of general formula (I) can be advantageously prepared by: 1) the step of synthesizing an organophosphorous compound by using 10-halogeno-10H-9-oxo-10-phosphaphenanthrene as the starting material and reacting this with a dihydric alcohol compound or a dihydric phenol compound, and 2) the step of oxidising the trivalent phosphorus of this organophosphorus compound to a pentavalent state using an oxidizing agent. Preparation can be more preferably carried out by the following method.

That is, the condensed phosphonic acid ester of the present invention can be advantageously prepared by a method of preparation which includes:

(A) the step (Step A) of using a compound of chemical formula (II) below

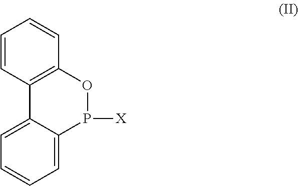

(where X is a halogen atom) and adding a dihydrate alcohol compound or a dihydrate phenol compound to the reaction system and effecting a dehydrohalogenation reaction, thereby synthesizing an organophosphorus compound of formula (III) below

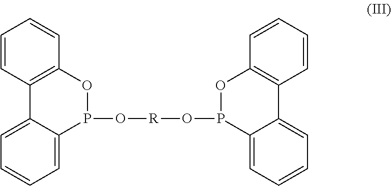

(where X is a C₁₋₁₁ ethylene group, C₁₋₁₁ arylene group, C₁₋₁₁ cycloalkylene group, C₁₋₁₁ heteroalkylene group, C₁₋₁₁ heterocycloalkylene group or C₁₋₁₁ heteroarylene group which optionally has a substituent); and
(B) the step (Step B) of oxidising, with the use of an oxidizing agent in the presence of an amine, the trivalent phosphorus atom on the above organophosphorous compound to a pentavalent state so as to obtain a phosphonic acid ester of above general formula (I).

In Step A, a compound of above chemical formula (II) and a dihydrate alcohol compound or dihydrate phenol, compound are added to a reaction system and a dehydrohalogenation reaction is effected, thereby synthesizing an organophosphorus compound of above general formula (I).

It suffices for the compound of general formula (II) to foe synthesized by the method of preparation described in Japanese Patent Application Publication No. 2007-223934 using commercially available 2-phenylphenol and phosphorus trichloride as the starting materials. In this case, the halogen atom of the compound of general formula (III) is chlorine (X═Cl). The dihydrate alcohol compound or dihydrate phenol compound may be suitably selected from among known or commercial products in accordance with the chemical structure and other attributes of the final target substance.

The method of synthesizing the compound of general formula (III) may involve merely mixing together both the compounds of general formula (II) and the dihydrate alcohol compound or dihydrate phenol compound at from, room temperature (about 18° C.) to 180° C. The mixing proportions are not particularly limited, and may foe set to from about 0.5 to about 1 mole, and preferably from about 0.5 to about 0.7 moles, of the dihydrate alcohol compound or dihydrate phenol compound per mole of the compound of general formula (II).

This reaction may be optionally carried out in a solvent. Examples of the solvent include, but are not particularly limited to, aprotic solvents such as hydrocarbon solvents (e.g., benzene, toluene, n-hexane), ethers (e.g., tetrahydrofuran, dioxane) and halogenated hydrocarbon solvents (e.g., dichloromethane, chloroform).

An amine may be optionally included in the reaction system as a catalyst to efficiently promote the above dehydrohalogenation reaction. Examples of the amine, although not particularly limited, include at least one from among triethylamine, pyridine, N,N-dimethylaniline, 1,8-diazabicyclo[5.4.0]-7-undecene, 1,5-diazabicyclo[4.3.0]-5-nonene and 4-dimethylaminopyridine. Of these, triethylamine is preferred, for economic reasons. The amount of catalyst added may be such as to make the amine present in a degree that serves as a catalytic amount for the above reaction, and may be suitably set according to, for example, the type of amine.

In Step B, the condensed phosphonic acid ester of the present invention is obtained by using an oxidizing agent in the presence or an amine to oxidize the trivalent phosphorus atom in the above organophosphorous compound to a pentavalent state.

No limitation is imposed on the method of oxidation. This may involve simply stirring and mixing together an organophosphorus compound of, for example, above general formula (III) and an oxidising agent. The reaction temperature in this case may be set to generally from about 0 to about 50° C. By optionally carrying out pH control via the addition of a small amount of amine, a hydrolysis reaction can be reduced, enabling the target substance to be obtained in a higher yield.

A known or commercial product may be used as the oxidising agent. Suitable use can be made of at least one type of peroxide such as hydrogen peroxide (aqueous), peracetic acid, perbenzoic acid and m-chloroperbenzoic acid. In this invention, hydrogen peroxide (aqueous) is especially preferred for economic and other reasons.

The amount of oxidising agent added may be suitably set according to, for example, the type of oxidising agent used. It is desirable to mix generally from about 2 to about 4 moles, and preferably from about 2.1 to about 2.5 moles, of the oxidizing agent per mole of the organophosphorus compound of general formula fill). In cases where the oxidation reaction is accompanied by vigorous heat generation, mixture may be carried out under dropwise addition.

The amine functions as a catalyst which efficiently promotes the above oxidation reaction. Such amines are exemplified by at least one of the following: triethylamine, pyridine, N,N-dimethylaniline, 1,8-diazabicyclo[5.4.0]-7-undecene, 1,5-diazabicyclo[4.3.0]-5-nonene and 4-dimethylaminopyridine. The amine may be suitably added in an amount, per mole of the organophosphorus compound of general formula (III), of from about 0.01 to about 0.1 moles, and preferably from about 0.02 to about 0.05 moles.

A solvent may be optionally used in Step B as well. Illustrative examples of the solvent include hydrocarbon solvents such as benzene, toluene and n-hexane; alcohol-based solvents such as methanol and isopropyl alcohol; and halogenated hydrocarbon solvents such as dichloromethane and chloroform.

To more efficiently promote a chain of reactions, the condensed phosphonic acid ester may be prepared by successively adding, with the completion of each reaction step, a dihydrate alcohol compound or dihydrate phenol compound and an oxidising agent to the same reaction system as at the start of the pathway synthesizing the compound or general formula (III). Alternatively, when an amine serving as a dehydrochlorination catalyst is also made present, because this acts as a catalyst in the subsequent oxidation reaction, the condensed phosphonic acid ester can be obtained more easily and reliably.

Following Step B, the phosphonic acid ester can be recovered by a known purification method, solid-liquid separation method or the like. In cases where the condensed phosphonic acid ester is synthesized by the preparation method of the present invention, it is possible to carry out refined production at a very high yield, enabling the target substance to be obtained, under good conditions, at a yield of 90% or more.

### (2) Secondary Ingredient (Flame Retardant Aid)

In addition to the condensed phosphonic acid ester of the present invention, a secondary ingredient may be optionally contained in the present flame retardant. For example, a flame retardant aid or promoter may be suitably used as a secondary ingredient.

Phosphorus-containing compounds other than the condensed phosphonic acid ester of the present invention, nitrogen-containing compounds, sulfur-containing compounds, silicon-containing compounds, inorganic metal compounds may foe suitably included as the flame retardant aid, providing doing so is not detrimental to the flame retarding function of the condensed phosphonic acid ester of the present invention.

Illustrative examples of such phosphorus-containing compounds include red phosphorus, non-condensed or condensed phosphoric acids such as phosphoric acid and phosphonic acid, and amine salts or metal salts thereof, inorganic phosphorus-containing compounds such as boron phosphate, orthophosphoric acid esters or condensation products thereof, phosphoric acid ester amides, phosphorus-containing ester compounds other than the above such as phosphonic acid esters or phosphinic acid esters. Illustrative examples of such nitrogen-containing compounds include triazine or triazole-type compounds or salts thereof (metal salts, (poly)phosphoric acid salts, sulfuric acid salts), urea compounds and (poly)phosphoric acid amides. Illustrative examples of such sulfur-containing compounds include organic sulfonic acids (alkanesulfonic acids, perfluoroalkanesulfonic acids, arenesulfonic acids) or metal salts thereof, sulfonated polymers, and organic sulfonic acid amides or salts thereof (ammonium salts, metal, salts). Illustrative examples of such silicon-containing compounds include silicone compounds such as resins, elastomer and oils containing (poly)organosiloxanes, and zeolites. Illustrative examples or inorganic metal compounds include metal salts of inorganic acids, metal oxides, metal hydroxides and metal sulfides. These flame retardant promoters may be used, singly or two or more may be used in combination.

The content of the flame retardant promoter, although not particularly limited, may be suitably set within a range, expressed as the weight ratio (condensed phosphonic acid ester of the present invention)/(flame retardant promoter), of from 1/100 to 500/1, and preferably from 10/100 to 200/1.

### (3) Use of the Present Flame Retardant

The present flame retardant is suitable for imparting flame retardance to resins (particularly synthetic resins), and can be advantageously used as a flame retardant for mixing with synthetic resins. That is, by being uniformly included in the resin, it is useful as a flame retardant for imparting the resin with flame retardance. The specific method of use may be the same as that for known or commercially available flame retardants of the same type. For example, by mixing the present flame retardant with resin so that it is uniformly included in the resin, flame retardance can be imparted to the resin. The method of mixture is not particularly limited, provided the present flame retardant can be uniformly mixed within the resin. For example, any method such as dry mixing, wet mixing or melt kneading may be used.

### 2. Flame-Retarded Resin Composition

The flame-retarded resin composition, of the present invention is a resin composition containing the present flame retardant and a resin component. The resin composition contains from 1 to 100 parts by weight of this condensed phosphonic acid ester per 100 parts by weight of the resin component. The components are each described below.

### (1) Flame Retardant

A flame retardant containing the condensed phosphonic acid ester of the present invention (present flame retardant) can foe used as the flame retardant.

The flame retardant content is generally set to from 1 to 100 parts by weight, and preferably from 1 to 50 parts by weight, per 100 parts by weight of the resin component. At a compositional, ratio for the flame retardant below 1 part by weight, the flame retardance is inadequate, whereas at more than 50 parts by weight, properties inherent, to the resin may cease to be obtained.

In cases where the present flame retardant includes a flame retardant promoter as a secondary ingredient, the content of the flame retardant promoter may be suitably set according to, for example, the type of flame retardant promoter used. For example, when a phosphorus-containing compound is used, the content may be set to from 1 to 100 parts by weight per 100 parts by weight of the resin component; when a nitrogen-containing compound is used, the content may be set to from 3 to 30 parts by weight per 100 parts by weight of the resin component; when a sulfur-containing compound is used, the content may be set to from 0.01 to 20 parts by weight per 100 parts by weight of the resin component; when a silicon-containing compound is used, the content may be set to from 0.01 to 10 parts by weight per 100 parts by weight of the resin component; and when an inorganic metal compound is used, the content may foe set to from 1 to 100 parts by weight per 100 parts by weight of the resin component.

### (2) Resin Component

The resin component mixed, into the flame-retarded resin composition of this invention is not particularly limited; use may be made of various resins (particularly synthetic resins) utilised for molding purposes. Illustrative examples include homopolymers or copolymers of thermoplastic resins or thermoset resins such as polyolefin resins, polystyrene resins, polyvinyl resins, polyamide resins, polyimide resins, polyester resins, polyether resins, polycarbonate resins, acrylic resins, polyacetal resins, polyetheretherketone resins, polyphenylene sulfide resins, polyamide-imide resins, polyethersulfone resins, polysulfone resins, polymethylpentene resins, urea resins, melamine resins, epoxy resins, polyurethane resins and phenolic resins, these being used either singly or as polymer alloys that are combinations thereof. Of the above, polystyrene resins, polyamide resins, polyester resins, polyether resins, polycarbonate resins and acrylic resins are especially preferred. In this invention, polycarbonate resins are even more preferred. Examples of resin components that may be used, in the present invention, are given below.

### Polyolefin Resins

Preferred use can be made of polyolefin resins. Including resins which are homo-polymers of α-olefins such as ethylene, propylene, 1-butene, 4-methyl-1-pentene, 1-hexene and 1-octane, or random or block copolymers of these α-olefins, either alone or as mixtures thereof; and resins obtained by copolymerizing these with, for example, vinyl, acetate or maleic anhydride. Illustrative examples include polypropylene resins such as propylene homopolymers, propylene-ethylene random copolymers, propylene-ethylene block copolymers and propylene-ethylene-butene copolymers; and polyethylene resins such as low-density ethylene homopolymers, high-density ethylene homopolymers, ethylene-α-olefin random copolymers, ethylene-vinyl acetate copolymers and ethylene-ethyl acrylate copolymers. These resins may be used singly or two or more may be used in combination. In the present invention, a polyethylene synthetic rubber, polyolefin synthetic rubber or the like may be compounded in order to improve the properties of the flame retarded resin composition.

### Polystyrene Resin

Illustrative examples of polystyrene resins include homopolymers and copolymers of styrene monomers such as styrene, vinyltoluene, α-methylstyrene and chlorostyrene; copolymers of a vinyl monomer such as an unsaturated nitriie (e.g., acrylonitrile), (meth)acrylic acid, a (meth)acrylic acid ester, an α,β-monoolefinic unsaturated carboxylic acid or acid anhydride (e.g., maleic anhydride), or an ester thereof with a styrene monomer; and styrene-based graft copolymers and styrene-based block copolymers. Preferred examples include polystyrene (GPPS), styrene-methyl (meth)acrylate copolymers, styrene-maleic anhydride copolymers, styrene-acrylonitrile copolymers (AS resins), impact-resistant polystyrenes obtained by polymerising styrene monomers with a rubber component (HIPS), and polystyrene graft or block copolymers. Exemplary polystyrene graft copolymers include copolymers in which at least a styrene monomer and a copolymerizable monomer are graft-polymerised to a rubber component (e.g., ABS resins in which styrene and acrylonitrile are graft-polymerized to polybutadiene, AAS resins in which styrene and acrylonitrile are graft-polymerised to acrylic rubber, polymers in which styrene and acrylonitrile are graft-polymerised to an ethylene-vinyl acetate copolymer, polymers in which styrene and acrylonitrile are graft-polymerised to an ethylene-propylene robber, MBS resins in which styrene and methyl methacrylate are graft-polymerised to polybutadiene, and resins in which styrene and acrylonitrile are graft-polymerised to styrene-butadiene copolymer rubber. Exemplary block copolymers include copolymers composed of polystyrene blocks and diene or olefin blocks (e.g., styrene-butadiene-styrene (SBS) block copolymers, styrene-isoprene block copolymers, styrene-isoprene-styrene (SIS) block copolymers, hydrogenated styrene-butadiene-styrene (SEBS) block copolymers and hydrogenated styrene-isoprene-styrene (SEPS) block copolymers. These styrene resins may be used singly or as combinations of two or more thereof.

Illustrative examples of polyvinyl resins include homopolymers and copolymers of vinyl monomers (e.g., vinyl esters such as vinyl acetate, vinyl propionate, vinyl crotonate, vinyl benzoate; chlorine-containing vinyl monomers such as vinyl chloride and chloroprene; fluorine-containing vinyl monomers such as fluoroethylene; vinyl ketones such as methyl vinyl ketone and methyl isopropenyl ketone; vinyl ethers such as vinyl methyl ether and vinyl isobutyl ether; and vinyl amines such as N-vinylcarbazole and N-vinylpyrrolidone), and copolymers of such vinyl monomers with other copolymerizable monomers. Derivatives of such vinyl resins (e.g., polyvinyl alcohols, polyvinyl acetals such as polyvinyl formal and polyvinylbutyral, ethylene-vinyl acetate copolymers and ethylene-vinyl alcohol copolymers) may also be used. These vinyl resins may foe used singly or two or more may be used in combination.

### Polyamide Resins

Exemplary polyamide resins include ring-opening polymers of, for example, ε-caprolactam, undecanelactam and lauryl lactam (ω-aminocarboxylic acid polymers), and copolycondensation products of diamines and dicarboxylic acids. Specific examples include polyamide 3, polyamide 6, polyamide 11, polyamide 12, polyamide 66, polyamide 610, polyamine 612, polyamide 6T, polyamide 6I and polyamide 9T. These polyamide resins may be used singly, or two or more may be used in combination.

### Polyester Resins

Exemplary polyester resins include homopolymers and copolymers in which an alkylene arylate unit such as alkylene terephthalate or alkylene naphthalate serves as a chief component. Illustrative examples include homopolymers such as polyethylene terephthalate (PET), polytripropylene terephthalate, polybutylene terephthalate (PBT), 1,4-cyclohexanedimethylene terephthalate (PCT), polyethylene naphthalate, polypropylene naphthalate and polybutylene naphthalate, as well as copolymers which contain an alkylene terephthalate and/or an alkylene naphthalate as a chief component and are not highly crystallised. Other preferred examples include glycol-modified polyesters (PETG) which are polymers wherein a given portion of the alkylene glycol that is a constituent component of polyalkylene terephthalate has been replaced with 1,4-cyclohexanedimethanol (CHDM). These polyester resins may be used singly or as combinations of two or more thereof.

### Polyether Resins

Exemplary polyether resins include polyalkylene ethers that are homopolymers of alkylene ethers or are obtained by the graft copolymerization of an alkylene ether with a styrene compound, and mixtures of a polyalkylene ether with a styrene polymer. Illustrative examples include polyalkylene ether homopolymers such as polyethylene glycol, polypropylene glycol, poly(2,6-dimethyl-1,4-phenylene) ether, poly(2-methyl-6-ethyl-1,4-phenylene) ether and poly(2,6-diethyl-1,4-phenylene) ether; and polyphenylene ethers obtained by graft copolymerizing a styrene compound such as styrene, α-methylstyrene, 2,4-dimethylstyrene, monochlorostyrene, dichlorostyrene, p-methylstyrene and ethylstyrene. Preferred examples include poly(2,6-dimethyl-1,4-phenylene) ether and poly(2,6-dimethyl-1,4-phenylene) ether to which polystyrene has been graft-copolymerized (modified polyphenylene ether). The polyphenylene oxide resin may foe used singly or as a combination of two or more thereof.

### Polycarbonate Resins

Exemplary polycarbonate resins include polymers obtained by reacting a dihydroxy compound with phosgene or a carbonic acid ester such as diphenyl carbonate. The dihydroxy compound may be an alicyclic compound, and is preferably a bisphenol compound. Illustrative examples of bisphenol compounds include bis(hydroxyaryl) C₁₋₆ alkanes such as bis (4 hydroxyphenyl)methane, 1,1-bis(4-hydroxyphenyl)propane, 2,2-bis(4-hydroxyphenyl)propane (bisphenol A), 2,2-bis(4-hydroxy-3-methylphenyl)propane, 2,2-bis(4-hydroxyphenyl)butane, 2,2-bis(4-hydroxyphenyl)-3-methylbutane, 2,2-bis(4-hydroxyphenyl)hexane and 2,2-bis(4-hydroxyphenyl)-4-methylpentane; bis(hydroxyaryl) C₄₋₁₀ cycloalkanes such as 1,1-bis(4-hydroxyphenyl)cyclopentane and 1,1-bis(4-hydroxyphenyl)cyclohexane; 4,4′-dihydroxydiphenyl ether; 4,4′-dihydroxydiphenylsulfone; 4,4′-dihydroxydiphenylsulfide; and 4,4′-dihydroxydiphenyl ketone. Preferred polycarbonate resins include bisphenol A-type polycarbonates. The polycarbonate resin may be used singly or as a combination of two or more thereof.

In this invention, a polycarbonate resin having a high molecular weight is desirable, with a polycarbonate resin having a viscosity-average molecular weight of from about 18,000 to about 100,000, and particularly from 20,000 to 30,000, being preferred. The melt volume flow rate (MVR) in the polycarbonate resin is preferably from 1 to 30, and most preferably from 2 to 10. The MVR in this case is measured in accordance with JIS K7210, with the test conditions being 300° C. and 1.2 kgf.

### Acrylic Resins

Exemplary acrylic resins include homopolymers and copolymers of (meth)acrylic monomers ((meth)acrylic acid or esters thereof), and also (meth)acrylic acid-styrene copolymers and methyl (meth)acrylate-styrene copolymers.

In addition to the various above-described resins, the synthetic resin (resin component) in this invention includes also alloy resins prepared by kneading together two or more resin components in the presence or absence of a suitable compatibilizing agent. Illustrative examples of such alley resins include polypropylene/polyamide, polypropylene/poly(butylene terephthalate), acrylonitrile-butadiene-styrene copolymer/poly(butylene terephthalate), acrylonitrile-butadiene-styrene copolymer/polyamide, polycarbonate/acrylonitrile-butadiene-styrene copolymer, polycarbonate/poly(methyl methacrylate), polycarbonate/polyamide, polycarbonate/poly(ethylene terephthalate) and polycarbonate/poly(butylene terephthalate).

In addition, modified forms of the above-described synthetic resins may be used. For example, it is possible to use a modified resin obtained by grafting an unsaturated carboxylic acid such as acrylic acid, methacrylic acid, maleic acid, fumaric acid, maleic anhydride or itaconic anhydride, or a siloxane, onto the above-described synthetic resins.

### (3) Additives

Additives contained in known resin compositions may be suitably included in the flame-retarded synthetic resin composition of the present invention, provided that doing so does not detract from the advantageous effects of the present invention.

Examples of such additives include: 1) antioxidants such as phenolic compounds, phosphine compounds and thioether compounds; 2) ultraviolet, absorbers or light-resisting agents such as benzophenone compounds, benzotriazole compounds, salicylate compounds and hindered amine compounds; 3) antistatic agents and electrically conductive materials such as cationic compounds, anionic compounds, nonionic compounds, amphoteric compounds, metal oxides, π-conductive polymer compounds and carbon; 4) lubricants such as fatty acids, fatty acid amides, fatty acid esters and metal salts of fatty acids; 5) nucleating agents such as benzylidene sorbitol compounds; 6) fillers such as talc, calcium carbonate, barium sulfate, mica, glass fibers glass beads and low-melting glass; and (7) other additives such as metal deactivators, colorants, anti-blooming agents, surface modifiers, anti-blocking agents, anti-fogging agents, pressure-sensitive adhesives, gas adsorbents, freshness enhancers, enzymes, deodorants and fragrances,

Also, a fluorine-containing polymer (fluoroplastic) having a fibril-forming ability may be included in the flame-retarded resin composition of the present invention. By adding a fluorine-containing polymer having a fibril-forming ability, the dripping preventive performance of a test piece when, burning in a flammability test on the flame-retarded resin composition, particularly the vertical burning test established as a standard by Underwriters Laboratories (UL) (UL 94V), can be further increased.

### (4) Method of Preparing Flame-Retarded Resin Composition

The flame-retarded resin composition of the present invention can be obtained by uniformly mixing together the above ingredients. Preparation is preferably carried out by melt kneading the above ingredients. No particular limitation is imposed on the kneading order in this case; that is, the respective ingredients may be mixed together at the same time, or several of the ingredients may first be mixed together, with the remainder being subsequently mixed in.

No limitation is imposed on the mixing method. For example, use may be made of a method involving the use, either alone or in combination, of any of the following apparatuses: a high-speed stirrer such as a V-type tumbler blender, a Henschel mixer or ribbon mixer, a single-screw or twin-screw continuous kneader, or a roll mixer.

In this invention, it is also possible to first prepare a high-concentration composition of several of the ingredients with synthetic resin as a masterbatch, then to dilute the masterbatch by mixing in more of the resin so as to obtain a predetermined resin composition.

### (5) Use of Flame-Retarded Resin Composition

The flame-retarded resin composition of the present invention has a high heat resistance, achieves an excellent flame retardance when added in a relatively small amount, and can be advantageously used in the manufacture of flame-retarded molded articles in which a good balance has been achieved between the physical properties and optical properties. That is, the flame-retarded resin composition of the present invention can be advantageously used as resin compositions for manufacturing a broad range of molded articles, from thin-wailed to thick-wailed products. It is possible in this way to provide molded products of excellent flame retardance.

### 3. Molded Articles

This invention also encompasses flame-retarded resin molded articles obtained by molding the flame-retarded resin composition of the present invention.

No particular limitation is imposed on the molding method; use can be made of known processes such as injection molding and extrusion. Examples of suitable methods include ones involving the use of an extruder; methods in which a sheet is produced, following which fabrication is carried cut by, for example, vacuum forming or pressing; and methods involving the use of an injection molding machine. In this invention, injection molding is especially preferred.

In cases where an injection molding process is employed, the molded article may be produced by an ordinary cold runner-type injection molding process, or by a hot runner-type that enables runner less molding to be carried out. In addition, use can also be made of, for example, gas-assist injection molding, injection compression molding and ultrahigh-speed injection molding.

Molded articles composed of the flame-retarded resin composition of the present invention, because they have an excellent flame retardance even when thin-walled and do not incur much loss in the various mechanical properties inherent to the resin, can be employed in the internal components and housings of office automation equipment and electrical appliances and in other components required to have flame retardance in the automotive field and elsewhere.

More specifically, molded, articles according to the present invention may be used in, for example, insulation-coated materials such as electrical wires and cables and various electrical components; various automotive applications such as the instrument panel, center console panel, lamp housing, lamp reflector, corrugated tubing, wire coatings, battery parts, car navigation components and car stereo components; boats, aircraft, components, various home equipment components such as sink components, toilet components, bathroom components, floor heating components, lighting fixtures and air conditioners; various construction materials such as roofing materials, ceiling material, wall materials and flooring materials; and electrical and electronic components such as relay cases, coil bobbins, light pickup chassis, motor case, notebook computer housings and internal components, CRT display housings and internal components, printer housings and internal components, handheld device housings and internal components, recording media (CDs, DVDs, PDs, etc.) driver housings and internal components, and copier housings surd internal components. Such molded articles can also foe advantageously used in applications such as household electrical appliances such as television sets, radios, video and audio recording devices, washing machines, refrigerators, vacuum cleaners, cookers and lamps, and are useful as well in various machine components and miscellaneous other applications.

### EXAMPLES

The present invention is described below in detail by way of working examples and comparative examples, although the present invention is in no way limited by these examples.

### 1. Synthesis of Condensed Phosphonic Acid Esters

Phosphonic acid esters of chemical formulas (1) to (5) were prepared in the synthesis examples described below. The synthesized phosphonic acid esters were identified and their physical properties measured by the following methods.

### (1) Purity

The purity was checked using a high-performance chromatography system equipped with a photodiode array (PDA) three-dimensional UV detector (Alliance HPLC System, available from Waters Corporation).

### (2) Melting Point

The melting point (melting point measurement by light transmission method) was measured with a fully automated melting point apparatus (FP-62, from Mettier-Toledo),

### (3) Elemental Analysis

Elemental analyses on the respective compounds were carried out using an elemental analyzer (EA1110, from CE Instruments Ltd.) for carbon and hydrogen, and following wet decomposition with a microwave sample digestion system (ETHOS1, from Milestone General), using the 720 ES inductively coupled plasma spectrometer (ICP-OES) from Varian for phosphorus.

### (4) Identification of Chemical Structure

Structural identifications of each of the product compounds were carried out from the IR spectrum obtained with an FT-720 infrared absorption spectrometer (FT-IR) from Horiba, Ltd., the hydrogen nuclear magnetic resonance (¹H-NMR) and phosphorus nuclear magnetic resonance (³¹P-NMR) spectra obtained with a 300 MHz NMR spectrometer (JNM-AL300, from JEOL, Ltd.), and the MS spectrum obtained with a mass spectrometer (JEOL JMS-AX505HA, from JEOL, Ltd.).

### Synthesis Example 1

A four-necked flask equipped with a stirrer and fitted with a dropping funnel with side arm and a thermometer was charged with 32.4 g of 9,10-dihydro-9-oxa-10-phosphaphenanthrene-10-oxide, 8.2 g of catechol, 17.2 g of triethylamine and 150 mL of dichloromethane, and the dropping funnel with side arm was charged with 30.8 g of carbon tetrachloride. Next, after attaching a calcium, chloride tube to the top end of the dropping funnel to as to prevent moisture within the air from entering into the reaction system, the flask was immersed in ice water and cooled to 10° C. The carbon tetrachloride was added dropwise in such a way that the temperature of the reaction mixture did not exceed 15° C., and stirring was continued for 1 hour following such addition. The reaction mixture was washed with a 2% aqueous sodium hydroxide solution and additionally washed with tap water and a saturated aqueous sodium chloride solution, following which it was dried over anhydrous magnesium sulfate. The dried reaction mixture was concentrated under reduced pressure, giving a crude product in the form of a yellow liquid which was then recrystallised from methanol-wafer, affording 32.3 g of a compound in the form of a white powder that melts at 179.2° C. (yield, 80%). This compound had a purity of 99.0%. Based on the results of IR, ¹H-NMR, ³¹P-NMR and elemental analyses, this compound was confirmed to be 1,2-bis[(9,10-dihydro-9-oxa-10-phosphaphenanthrene-10-oxide-10-yl)oxy]benzene of chemical formula (12).

Elemental Analysis: C₃₀H₂₀O₆P₂. Calculated: C, 66.92; H, 3.74, P, 11.51. Found: C, 66.70; H, 3.66; P, 11.48. IR: 3062, 1597, 1496, 1435, 1288, 1257, 1203, 1157, 1103, 1041, 933, 756, 717, 609, 523, 440 cm⁻¹. ¹H-NMR (CDCl₃, 300 MHz): δ6.93-7.88 ppm (20H, m, Ph). ³²P-NMR (CDCl₃, 109 MHz); δ7.15 ppm.

### Synthesis Example 2

Aside from changing the 8.2 g of catechol to 8.2 g of resorcinol, the reaction was carried out in the same way as in Synthesis Example 1, giving 33.5 g of, as white crystals, a compound melting at 158.5° C. (yield, 88%). This compound had a purity of 99.2%. Based on the results of IR, ¹H-NMR, ³¹P-NMR and elemental analyses, this compound was confirmed to be 1,3-bis[(9,10-dihydro-9-oxa-10-phosphaphenanthrene-10-oxide-10-yl)oxy]benzene of chemical formula (14).

Elemental Analysis: C₃₀H₂₀O₆P₂. Calculated: C, 66.92; H, 3.74, P, 11.51. Found: C, 66.65; H, 3.52; P, 11.53. IR: 3070, 1597, 1481, 1435, 1273, 1242, 1203, 1119, 1080, 980, 941, 795, 756, 687, 601, 532, 424 cm⁻¹. ¹H-NMR (CDCl₃, 300 MHz): δ6.78-8.03 ppm (20H, m, Ph). ³¹P-NMR (CDCl₃, 109 MHz): δ7.02 ppm.

### Synthesis Example 3

Aside from changing the 8.2 g of catechol to 8.2 g of hydroquinone, the reaction was carried out in the same way as in Synthesis Example 1, giving 34.3 g of, as white crystals, a compound melting at 216.5° C. (yield, 85%). This compound had a purity of 98.7%. Based on the results of IR, ¹H-NMR, ³¹P-NMR and elemental analyses, this compound was confirmed to be 1,4-bis[(9,10-dihydro-9-oxa-10-phosphaphenanthrene-10-oxide-10-yl)oxy]benzene of chemical formula (13).

Elemental Analysis: C₃₀H₂₀O₆P₂. Calculated: C, 66.92; H, 3.74, P, 11.51. Found: C, 66.86; H, 4.01; P, 11.39. IR: 3070, 1597, 1496, 1427, 1230, 1234, 1180, 1118, 933, 841, 755, 717, 601, 548, 509, 424 cm⁻¹. ¹H-NMR (CDCl₃, 300 MHz); δ6.92-8.02 ppm (20H, m, Ph). ³¹P-NMR (CDCl₃, 109 MHz): δ7.15 ppm.

### Synthesis Example 4

Aside from changing the 8.2 g of catechol to 4.66 g of ethylene glycol, the reaction was carried out in the same way as in Synthesis Example 1, giving 27.2 g of, as white crystals, a compound melting at 167.9° C. (yield, 74%). This compound had a purity of 99.3%. Based on the results of IR, ¹H-NMR, ³¹P-NMR and elemental analyses, this compound was confirmed to be 1,2-bis[(9,10-dihydro-9-oxa-10-phosphaphenanthrene-10-oxide-10-yl)oxy]ethane of chemical formula (9).

Elemental Analysis: C₂₆H₂₀O₆P₂. Calculated: C, 63.68; H, 4.11, P, 12.63. found: C, 63.62; H, 4.17; P, 12.65. IR: 3070, 2962, 2908, 1589, 1473, 1435, 1273, 1203, 1157, 1119, 1026, 926, 756, 687, 601, 540, 517, 416 cm⁻¹. ¹H-NMR (CDCl₃, 300 MHz): δ4.19−4.03 ppm (4H, m, OCH₂CH₂O), δ7.09-7.96 ppm (16H, m Ph). ³¹P-NMR (CDCl₃, 109 MHz): δ1.11 ppm.

### Synthesis Example 5

Aside from changing the 8.2 g of catechol to 7.8 g of neopentyl glycol, the reaction was carried out in the same way as in Synthesis Example 1, giving 8.0 g of, as white crystals, a compound melting at 207.7° C. (yield, 20%). This compound had a purity of 98.8%. Based on the results of IR, ¹H-NMR, ³¹P-NMR, MS and elemental analyses, this compound was confirmed to be 1,3-bis[(9,10-dihydro-9-oxo-10-phosphaphenanthrene-10-oxide-10-yl)oxy]-2,2-dimethylpropane of chemical formula (10). Prom the ¹H-NMR and ³¹P-NMR spectra, the presence of asymmetric phosphorus atoms confirmed the formation of a diastereomer.

Elemental Analysis: C₂₉H₂₆O₆P₂. Calculated: C, 65.42; H, 4.92, P, 11.63. Found: C, 65.05; H, 5.17; P, 11.51, IR: 3051, 2970, 2883, 1595, 1477, 1292, 1270, 1192, 1139, 1119, 1114, 1060, 1004, 941, 836, 796, 526, 480, 410 cm⁻¹. ¹H-NMR (CDCl₃, 300 MHz): δ0.49, 0.56 ppm (3H, s, CH₃), δ1.08 ppm (3H, s, CH₃), δ3.22-3.48, 3.56-3.63, 3.78-3.91 ppm (4H, m, CH₂O), δ6.81-7.93 ppm (16H, m, CH₃). ³¹P-NMR (CDCl₃, 109 MHz) δ6.01, 6.24, 11.51, 12.09 ppm. M⁺: m/z=533 (Mw, 532.46).

### 2. Preparation of Flame-Retarded Synthetic Resin Compositions

Flame-retarded synthetic resin compositions were prepared using the phosphonic acid esters obtained in the respective above synthesis examples. The ingredients making up the flame-retarded synthetic resin compositions included the synthetic resins and flame retardants indicated below. The ingredients shown below were dry blended in the compounding proportions (parts by weight) indicated in Tables 1 to 3, following which they were melt mixed and kneaded by extrusion in a twin-screw extruder, and the extruded strand was cut into pellets, giving a flame-retarded resin composition in the form of pellets. The twin-screw extruder used was a model KTX30 twin-screw extruder (manufactured by Kobe Steel, Ltd.; screw diameter, 30 mm; L/D=37; vented).

### Synthetic Resins

A-1: Panlite L-1225L (a polycarbonate available from Teijin Chemicals, Ltd.; MVR=18)
A-2: Panlite L-1250Y (a polycarbonate available from Teijin Chemicals, Ltd.; MVR=8)
A-3: Novarex 7030PJ (a polycarbonate available from Mitsubishi Engineering Plastics Corporation; MVR=2.2)
A-4: Eastar GN-001 (PET-G, available from Eastman Chemical Co.)

### Flame Retardants

B1: Compound (12)
B-2: Compound (14)
B-3: Compound (9)
B4: Compound (10)
B-5: Compound (19), which is 10-dihydro-9-oxa-10-phenoxy-10-phosphaphenanthrene-10-oxide (prepared according to one method described in Japanese Patent Application Publication No. 2003-108089; shown below as compound formula (19)).

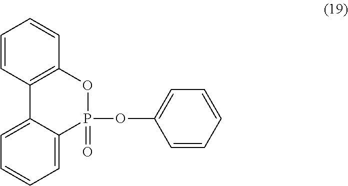 [SMILES: O=P1(Oc2ccccc2)Oc2ccccc2-c2ccccc21]

B-6: Compound (7), which is 4,4′-bis[(9,10-dihydro-9-oxa-10-phosphaphenanthrene-10-oxide-10-yl)oxy]-2,2′-diphenylpropane (prepared according to the method described in Japanese Patent Application Publication No. 2009-108089; shown below as compound formula (7)).

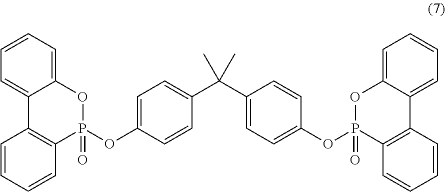 [SMILES: CC(C)(c1ccc(OP2(=O)Oc3ccccc3-c3ccccc32)cc1)c1ccc(OP2(=O)Oc3ccccc3-c3ccccc32)cc1]

B-7: PX-200 (available from Daihachi Chemical Industry Co., Ltd.; shown below as compound formula (2)).

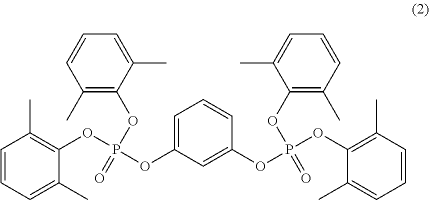 [SMILES: Cc1cccc(C)c1OP(=O)(Oc1cccc(OP(=O)(Oc2c(C)cccc2C)Oc2c(C)cccc2C)c1)Oc1c(C)cccc1C]

3. Evaluation of Various Properties of Molded Articles Obtained from Flame-Retarded Resin Compositions

Molded articles were produced by an injection molding process using the flame-retarded synthetic resin compositions obtained as described above. Injection molding was carried out using a model FE80S injection molding machine (available from Nissei Plastic Industrial Co., Ltd.; clamping pressure, 80 metric tons). The test pieces obtained were conditioned for 48 hours at 23° C. and 50% RH, following which the flammability and other properties of each were evaluated. The results are shown in Tables 1 to 3. These evaluations were carried out by the methods described below.

### (1) Flammability

The flammability was evaluated in accordance with the vertical burning test method of UL 94 by fabricating 3.2 mm (⅛ inch) thick test pieces, 1.6 mm ( 1/16 inch) thick test pieces and 0.8 mm ( 1/32 inch) thick test pieces, then carrying out vertical burning tests on these test pieces. The UL 94 vertical burning test results were given, one of four ratings: V-0, V-1, V-3 and Burn, (complete combustion). The results are shown, in Table 1 to 3.

### (2) Flow Properties

To evaluate the flow properties, the melt volume flow rate (MVR) was measured with a melt indexer (S-111, available from Toyo Seiki Co., Ltd.). The MVR was measured in accordance with JIS K7210. The test conditions were set to 300® C. and 1.2 kgf. The results are shown in Table 3.

### (3) Izod Impact Strength

The Izod impact test pieces (3.2 mm) described in JIS K7110 were fabricated, following which notches were cut in the specimens and the Izod impact strength was measured in accordance with JIS K7110. The results are shown in Table 3.

### (4) Optical Characteristics

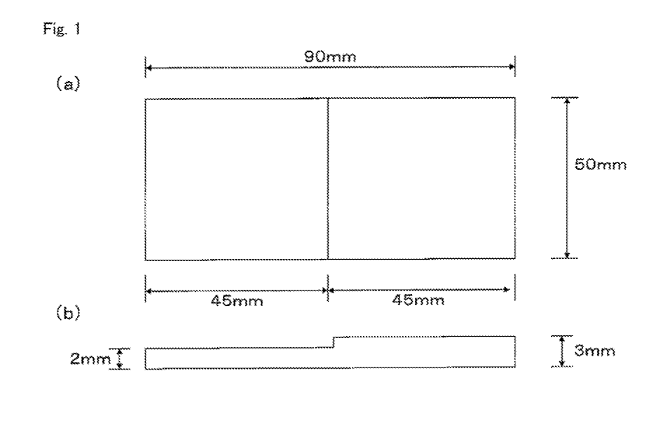

Flat test pieces (90 mm×50 mm) having a thickness of 2 mm/3 mm as shown in FIG. 1 were fabricated by injection molding, then subjected to 48 hours of conditioning treatment (aging treatment) at 23° C. and 50% RH, after which the total light transmittance and have of the test pieces were measured. The optical characteristics were evaluated by carrying out measurements of the total light transmittance and hare for each test specimen with a haze meter (TC-HIII, available from Tokyo Denshoku Kogyo KK). Each measurement was carried out at a thickness of 3 mm in accordance with JIS K7105 (Transmission Method). The results are shown in Table 3.

### (5) Heat Resistance

Evaluations of the thermogravimetric-differential thermal analysis changes obtained with a thermogravimetry/differential thermal analysis (TG/DTA) system (available as TG-DTA220U from SSI Nanotechnology KK) were carried out, and thermal gravimetric changes (heat resistances) for each of the flame retardants B-1 to B-7 were evaluated from the TG-DTA chart. The measurements were carried out in the range of 30 to 500° C. at a temperature ramp-up rate of 10° C./min and an air intake rate of 200 mL/min. The results are shown in Table 4.

TABLE 1

| | Synthetic | | | | | | | | | | |
|---|---|---|---|---|---|---|---|---|---|---|---|
| | resin | Flame retardant | | | | | | | UL 94V | | |
| PC | A-2 | B-1 | B-2 | B-3 | B-4 | B-5 | B-6 | B-7 | 0.8 mm | 1.5 mm | 3.2 mm |
| Comp. Ex. 1 | 100 | — | — | — | — | — | — | — | V-2 | V-2 | V-2 |
| Example 1 | 90 | 10 | — | — | — | — | — | — | V-0 | V-0 | V-0 |
| Example 2 | 85 | 15 | — | — | — | — | — | — | V-0 | V-0 | V-0 |
| Example 3 | 90 | — | 10 | — | — | — | — | — | V-0 | V-0 | V-0 |
| Example 4 | 85 | — | 15 | — | — | — | — | — | V-0 | V-0 | V-0 |
| Example 5 | 90 | — | — | 10 | — | — | — | — | V-0 | V-0 | V-0 |
| Example 6 | 85 | — | — | 15 | — | — | — | — | V-0 | V-0 | V-0 |
| Example 7 | 90 | — | — | — | 10 | — | — | — | V-0 | V-0 | V-0 |
| Example 8 | 85 | — | — | — | 15 | — | — | — | V-0 | V-0 | V-0 |
| Comp. Ex. 2 | 90 | — | — | — | — | 10 | — | — | V-2 | V-2 | V-2 |
| Comp. Ex. 3 | 85 | — | — | — | — | 15 | — | — | V-2 | V-2 | V-0 |
| Comp. Ex. 4 | 90 | — | — | — | — | — | 10 | — | V-2 | V-2 | V-2 |
| Comp. Ex. 5 | 85 | — | — | — | — | — | 15 | — | V-0 | V-0 | V-0 |
| Comp. Ex. 6 | 90 | — | — | — | — | — | — | 10 | V-2 | V-2 | V-2 |
| Comp. Ex. 7 | 85 | — | — | — | — | — | — | 15 | V-2 | V-2 | V-2 |

TABLE 2

| | Synthetic | | | | | | | | | | |
|---|---|---|---|---|---|---|---|---|---|---|---|
| | resin | Flame retardant | | | | | | | UL 94V | | |
| PET-G | A-4 | B-1 | B-2 | B-3 | B-4 | B-5 | B-6 | B-7 | 0.8 mm | 1.6 mm | 3.2 mm |
| Comp. Ex. 8 | 100 | — | — | — | — | — | — | — | V-2 | V-2 | V-2 |
| Example 9 | 90 | 10 | — | — | — | — | — | — | V-0 | V-0 | V-0 |
| Example 10 | 85 | 15 | — | — | — | — | — | — | V-0 | V-0 | V-0 |
| Example 11 | 90 | — | 10 | — | — | — | — | — | V-0 | V-0 | V-0 |
| Example 12 | 85 | — | 15 | — | — | — | — | — | V-0 | V-0 | V-0 |
| Example 13 | 90 | — | — | 10 | — | — | — | — | V-0 | V-0 | V-0 |
| Example 14 | 85 | — | — | 15 | — | — | — | — | V-0 | V-0 | V-0 |
| Example 15 | 90 | — | — | — | 10 | — | — | — | V-0 | V-0 | V-0 |
| Example 16 | 85 | — | — | — | 15 | — | — | — | V-0 | V-0 | V-0 |
| Comp. Ex. 9 | 90 | — | — | — | — | 10 | — | — | V-2 | V-2 | V-2 |
| Comp. Ex. 10 | 85 | — | — | — | — | 15 | — | — | V-2 | V-2 | V-0 |
| Comp. Ex. 11 | 90 | — | — | — | — | — | 10 | — | V-2 | V-0 | V-0 |
| Comp. Ex. 12 | 85 | — | — | — | — | — | 15 | — | V-2 | V-0 | V-0 |
| Comp. Ex. 13 | 90 | — | — | — | — | — | — | 10 | V-2 | V-2 | V-2 |
| Comp. Ex. 14 | 85 | — | — | — | — | — | — | 15 | V-2 | V-2 | V-2 |

TABLE 3

| | | | | | | | | | Izod | | | | | |
|---|---|---|---|---|---|---|---|---|---|---|---|---|---|---|
| | | | | | | | | MVR | impact | Total light | | | | |
| | Synthetic resins | | | Flame retardants | | | | (cm³/10 | test | transmittance | | UL 94V | | |
| PC | A-1 | A-2 | A-3 | B-2 | B-3 | B-5 | B-6 | min) | (J/m) | (%) | Haze | 0.8 mm | 1.6 mm | 3.2 mm |
| Comp. Ex. 15 | 100 | — | — | — | — | — | — | 18 | N.B. | 89.7 | 0.7 | V-2 | V-2 | V-2 |
| Example 17 | 90 | — | — | 10 | — | — | — | 69 | 31 | 89.5 | 0.7 | V-0 | V-0 | V-0 |
| Example 18 | 85 | — | — | 15 | — | — | — | 118 | 26 | 89.3 | 0.8 | V-0 | V-0 | V-0 |
| Example 19 | 90 | — | — | — | 10 | — | — | 62 | 27 | 89.7 | 0.6 | V-0 | V-0 | V-0 |
| Example 20 | 85 | — | — | — | 15 | — | — | 120 | 25 | 89.7 | 0.5 | V-0 | V-0 | V-0 |
| Comp. Ex. 16 | 90 | — | — | — | — | 10 | — | 70 | 23 | 89.6 | 0.7 | V-0 | V-0 | V-0 |
| Comp. Ex. 17 | 85 | — | — | — | — | 15 | — | 122 | 24 | 89.7 | 0.5 | V-0 | V-0 | V-0 |
| Comp. Ex. 18 | 90 | — | — | — | — | — | 10 | 77 | 21 | 89.5 | 0.8 | V-0 | V-0 | V-0 |
| Comp. Ex. 19 | 85 | — | — | — | — | — | 15 | 140 | 20 | 89.5 | 1.0 | V-0 | V-0 | V-0 |
| Comp. Ex. 20 | — | 100 | — | — | — | — | — | 8 | N.B. | 90.3 | 0.2 | V-2 | V-2 | V-2 |
| Example 21 | — | 90 | — | 10 | — | — | — | 42 | 41 | 89.5 | 0.7 | V-0 | V-0 | V-0 |
| Example 22 | — | 85 | — | 15 | — | — | — | 66 | 32 | 88.4 | 0.9 | V-0 | V-0 | V-0 |
| Example 23 | — | 90 | — | — | 10 | — | — | 38 | 38 | 89.7 | 0.3 | V-0 | V-0 | V-0 |
| Example 24 | — | 85 | — | — | 15 | — | — | 63 | 29 | 89.7 | 0.3 | V-0 | V-0 | V-0 |
| Comp. Ex. 21 | — | 90 | — | — | — | 10 | — | 43 | 35 | 90.2 | 0.4 | V-2 | V-2 | V-2 |
| Comp. Ex. 22 | — | 85 | — | — | — | 15 | — | 66 | 26 | 90.1 | 0.5 | V-2 | V-2 | V-0 |
| Comp. Ex. 23 | — | 90 | — | — | — | — | 10 | 45 | 35 | 89.9 | 0.6 | V-2 | V-2 | V-2 |
| Comp. Ex. 24 | — | 85 | — | — | — | — | 15 | 69 | 25 | 89.9 | 0.6 | V-0 | V-0 | V-0 |
| Comp. Ex. 25 | — | — | 100 | — | — | — | — | 2.2 | N.B. | 90.2 | 0.2 | V-2 | V-2 | V-2 |
| Example 25 | — | — | 90 | 10 | — | — | — | 16 | 40 | 89.3 | 0.6 | V-0 | V-0 | V-0 |
| Example 26 | — | — | 85 | 15 | — | — | — | 27 | 33 | 89.1 | 0.9 | V-0 | V-0 | V-0 |
| Example 27 | — | — | 90 | — | 10 | — | — | 15 | 39 | 89.6 | 0.3 | V-0 | V-0 | V-0 |
| Example 28 | — | — | 85 | — | 15 | — | — | 29 | 28 | 89.7 | 0.3 | V-0 | V-0 | V-0 |
| Comp. Ex. 26 | — | — | 90 | — | — | 10 | — | 17 | 37 | 89.5 | 0.6 | V-2 | V-2 | V-2 |
| Comp. Ex. 27 | — | — | 85 | — | — | 15 | — | 21 | 28 | 89.5 | 0.6 | V-2 | V-2 | V-2 |
| Comp. Ex. 28 | — | — | 90 | — | — | — | 10 | 20 | 36 | 89.6 | 0.6 | V-2 | V-2 | V-2 |
| Comp. Ex. 29 | — | — | 85 | — | — | — | 15 | 29 | 25 | 89.7 | 0.7 | V-0 | V-0 | V-0 |

TABLE 4

| | | Results of TG-DTA measurements for flame retardants (° C.) | | | | | Radical |
|---|---|---|---|---|---|---|---|
| | | Appearance | Melting | | | Weight loss | content in |
| | | at standard | point | 1% weight | 5% weight | extrapolation | compound* |
| Flame retardant | | temperature | (DTA peak) | loss point | loss point | point | (%) |
| Example 29 | B-1 | white solid | 199 | 314 | 340 | 387 | 80 |
| Example 30 | B-2 | white solid | 162 | 341 | 373 | 430 | 80 |
| Example 31 | B-3 | white solid | 173 | 337 | 357 | 358 | 88 |
| Example 32 | B-4 | white solid | 213 | 328 | 350 | 350 | 81 |
| Comp. Ex. 30 | B-5 | white solid | 103 | 229 | 265 | 285 | 70 |
| Comp. Ex. 31 | B-6 | colorless | — | 145 | 388 | 458 | 66 |
| | | viscous | | | | | |
| | | liquid | | | | | |
| Comp. Ex. 32 | B-7 | white solid | 97 | 279 | 321 | 369 | — |

Radical content*: The content of 9,10-dihydro-9-oxa-10-phosphaphenanthrene-10-oxide-10-yl radicals (Mw, 215.16) in a compound is indicated here.

As is apparent from the results in Tables 1 and 2, in the molded articles of the comparative examples, it is difficult to impart the synthetic resins with, a high degree of flame retardance by relatively low concentration of flame retardant. In contrast, in the molded articles according to the present invention, excellent flame retardance is imparted to synthetic resins such as polycarbonate resins and polyester resins, even with relatively low concentrations of flame retardant (18 parts by weight or less, especially 15 parts by weight or less, and even 12 parts by weight or less, per 100 parts by weight of the resin component).

As shown in Table 1, in each of Examples 1 to 8, with the addition of about 10 to 15 wt % of flame retardant to the resin composition, the flammability rating achieved was V-0 for all the test specimen thicknesses (0.8 mm, 1.6 mm and 3.2 mm). It is apparent from Table 2 that, as in Table 1, in each of Examples 10 to 16, with the addition of about 10 to 15 wt % of flame retardant to polyester compositions, the flammability rating achieved was V-0 for all the test specimen thicknesses (0.8 mm, 1.6 mm and 3.2 mm). This indicates that the flame retardant compounds of the present invention have a much higher flame-retarding ability than the known flame retardants shown in the comparative examples.

The results in Table 3 compare the influence on flame retarding ability and resin properties when flame retardants according to the present invention are added to various polycarbonate resins of differing molecular weights.

It is apparent from Examples 21 to 24 and Examples 25 to 28 that, in cases where flame retardants are added to polycarbonate resins (A-2 and A-3) of relatively high molecular weight (MVR=8 and 2.2; corresponding respectively to Comparative Examples 20 and 25), when the flame retardant of the present invention is added in a relatively small amount to about 10 to 15 wt % of the resin composition, flame-retarded resin compositions and flame-retarded resin moldings wherein a good balance is achieved among various properties such as flame retardance, physical properties and optical characteristics can be obtained.

Upon comparing these results with those obtained in Comparative Examples 21 to 24 and Comparative Examples 26 to 29, it is apparent that, unlike the condensed phosphonic acid esters of the present invention, conventional phosphonic acid ester-type flame retardants and condensed phosphoric acid ester-type flame retardants are unable to achieve both a high degree of flame retardance and optical properties inherent to the resin.

Table 4 shows the results of heat resistance evaluations on different flame retardants. In Examples 29 to 32, each of the flame retardants exhibited a white solid state at standard temperature, both the 1% weight loss temperature and the 5% weight loss temperature was 300° C. or more, and the melting point (DTA peak temperature) was at least 100° C. These findings indicate that processing can be stably carried out even on resins which are kneaded together with the flame retardant at temperatures exceeding 300° C. as is the case with engineering plastics such as polycarbonate resins. In each of Comparative Examples 30 to 32, the 1% weight loss temperature fell below 300° C. As a result, it was clear that, during the high-temperature thermal processing of engineering plastics and the like, some of the flame retardant itself thermally decomposes or volatilizes, generating decomposition gases (fumes) due to decomposition or leading to a decline in processability due to volatilization of the fire retardant. The flame retardants in Comparative Examples 30 and 32 were solids having melting points close to 100° C., and the flame retardant in Comparative Example 31 was a highly viscous liquid substance that does not exhibit a melting point. Hence, in each of these cases, the plasticity was strong. This is also supported by the fact that in Table 3, the MVR values for the comparative examples are higher than those for the examples of the present invention.

In Table 4, upon comparing the contents, within the structures of the respective compounds, of the 9,10-dihydro-9-oxo-10-phosphenanthrene-10-oxide-10-yl groups which exhibit a radical trapping ability in the condensed phosphonic acid ester molecules, this content was 70% or less in Comparative Examples 30 to 32, whereas it was more than 80% in each of Examples 29 to 32 according to the present invention. This suggests that a high heat resistance and a high content of radical functional groups which exhibit a radical trapping ability are both achieved in the flame retardants of Examples 29 to 32. By thus enabling a high flame retardance to be conferred with the addition of a smaller amount of flame retardant to the resin, decreases in the properties of the resin can be held to a minimum.

It is apparent from these results that, compared with the conventional phosphorus-based flame retardants used in the comparative examples, the condensed phosphonic acid ester-based flame retardants of this invention, owing to a distinctive flame-retarding mechanism not previously seen, can be made highly compatible with resins. Hence, owing to this distinctive flame retarding mechanism, it is possible with the addition of a relatively small amount of flame retardant to achieve a high degree of flame retardance while at the same time ensuring various properties of the resin, such as the flow properties, impact strength and transparency.

1. A flame retardant for resins, comprising a condensed phosphonic acid ester represented by general formula (I) below: 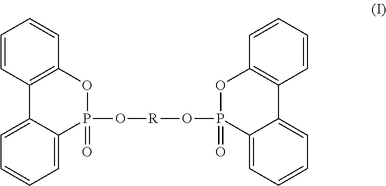
wherein R is an alkylene group, arylene group, cycloalkylene group, heteroalkylene group, heterocycloalkylene group or heteroarylene group, wherein fee group has a total carbon number of from 1 to 11 which may have a substituent.

2. A flame-retarding resin composition comprising the flame retardant of claim 1 and a resin component, wherein the composition contains 1 to 100 parts by weight of the condensed phosphonic acid ester per 100 parts by weight of the resin component.

3. The flame-retarding resin composition according to claim 2, wherein the resin component is a polycarbonate resin.

4. The flame-retarding resin composition according to claim 3, wherein the polycarbonate resin has a melt volume flow rate of from 1 to 30.

5. A flame-retarded resin molded article which is obtained by molding the flame-retarded resin composition according to claim 2.

6. The flame-retarded resin molded article according to claim 5 which is for use in electrical and electronic components, office automation equipment components, electrical appliance components, automotive components or machinery components.

7. A flame-retarded resin molded article which is obtained by molding the flame-retarded resin composition according to claim 3.

8. A flame-retarded resin molded article which is obtained by molding the flame-retarded resin composition according to claim 4.

9. The flame-retarded resin molded article according to claim 7 which is for use in electrical and electronic components, office automation equipment components, electrical appliance components, automotive components or machinery components.

10. The flame-retarded resin molded article according to claim 8 which is for use in electrical and electronic components, office automation equipment components, electrical appliance components, automotive components or machinery components.
